(19) United States
(12) Patent Application Publication
(10) Pub. No.: US 2020/0198603 A1
(43) Pub. Date: Jun. 25, 2020

(54) BRAKE CONTROL DEVICE

(71) Applicant: ADVICS CO., LTD., Kariya-shi, Aichi-ken (JP)

(72) Inventors: Tomotaka ASANO, Toyota-shi, Aichi-ken (JP); Takayuki YAMAMOTO, Nagakute-shi, Aichi-ken (JP); Yasuhito ISHIDA, Toyokawa-shi, Aichi-ken (JP); Tatsushi KOBAYASHI, Kariya-shi, Aichi-ken (JP); Kunihiro NISHIWAKI, Toyota-shi, Aichi-ken (JP)

(73) Assignee: ADVICS CO., LTD., Kariya-shi, Aichi-ken (JP)

(21) Appl. No.: 16/623,646

(22) PCT Filed: Jun. 25, 2018
(86) PCT No.: PCT/JP2018/024028

§ 371 Date: Dec. 17, 2019

(30) Foreign Application Priority Data
Jun. 28, 2017 (JP) 2017-126150

(51) Int. Cl. B60T 8/172; B60T 8/171; B60T 17/22

(52) U.S. Cl. CPC B60T 8/172; B60T 17/22; B60T 8/171

(57) ABSTRACT

A brake control device has: a first control unit which controls a first pressurizing mechanism capable of pressurizing a brake fluid using one pressurizing mode among a plurality of set pressurizing modes; and a second control unit which controls a second pressurizing mechanism separate from the first pressurizing mechanism and capable of pressurizing the brake fluid pressurized by the first pressurizing mechanism, wherein the first and second control units perform cooperative control based on the control information. The brake control device includes a mode estimation unit for estimating the current pressurizing mode set in the first pressurizing mechanism when the transfer of the control information is blocked. The second control unit is provided with a specific control unit which, in a state in which the transfer of the control information is blocked, controls the second pressurizing mechanism according to the pressurizing mode estimated by the mode estimation unit.

### TECHNICAL FIELD

The present invention relates to a brake control device configured to control two pressurizing mechanisms.

### BACKGROUND ART

A brake control device is a device including a first control unit configured to control one pressurizing mechanism of two pressurizing mechanisms and a second control unit configured to control the other pressurizing mechanism, and configured to execute a cooperative control of both the mechanisms by communication between both the control units. In the conventional device, when communication between both the control units is interrupted, each control unit sets a slightly high target deceleration, assuming that the other pressurizing mechanism is not normal. Therefore, during the communication interruption, when both the pressurizing mechanisms are normal, braking force may be excessive.

Therefore, for example, in a brake control device disclosed in WO2016/136671, when communication between two control units is interrupted, a second control unit executes a backup control of pressurizing a brake fluid in a wheel cylinder. During the backup control, when a pressure in a master cylinder exceeds a predetermined value, a pressurizing amount to the wheel cylinder is reduced. Thereby, it is possible to prevent the braking force from being excessive.

### CITATION LIST

### Patent Literature

PTL 1: WO2016/136671

### SUMMARY OF INVENTION

### Technical Problem

However, in the brake control device, since the determination as to whether or not to reduce the pressurizing amount of a hydraulic pressure control mechanism is performed on the basis of only the pressure in the master cylinder, the pressurizing amount is not changed until a somewhat high pressure in the master cylinder is detected. That is, the braking force may be excessive until a driver's brake operation increases to some extent.

The present invention has been made in view of the above situations, and an object thereof is to provide a brake control device capable of preventing braking force from being excessive with accuracy.

### Solution to Problem

A brake control device of the present invention includes a first control unit configured to control a first pressurizing mechanism capable of pressurizing a brake fluid with one pressurizing mode of a plurality of set pressurizing modes, a second control unit configured to control a second pressurizing mechanism provided separate from the first pressurizing mechanism and capable of pressurizing the brake fluid pressurized by the first pressurizing mechanism, and a communication line configured to transfer control information between the first control unit and the second control unit, wherein the first control unit and the second control unit are configured to perform a cooperative control on the basis of the control information, wherein the brake control device is provided with a mode estimation unit for estimating the current pressurizing mode set in the first pressurizing mechanism when the transfer of the control information between the first control unit and the second control unit is interrupted, and wherein the second control unit is provided with a specific control unit configured to control the second pressurizing mechanism according to the pressurizing mode estimated by the mode estimation unit in a state in which the transfer of the control information is interrupted.

### Advantageous Effects of Invention

According to the present invention, when the transfer of the information between both the control units is blocked, the mode estimation unit estimates the current pressurizing mode of the first pressurizing mechanism, and the specific control unit controls the second pressurizing mechanism, in correspondence to the estimated pressurizing mode. For this reason, it is possible to early execute a control suitable for a state of the first pressurizing mechanism, so that it is possible to accurately prevent the braking force from being excessive.

### BRIEF DESCRIPTION OF DRAWINGS

FIG. 1 is a configuration view of a brake device for a vehicle in accordance with a first embodiment.

FIG. 2 is a configuration view of a regulator in accordance with the first embodiment.

FIG. 3 is a configuration view of an actuator in accordance with the first embodiment.

FIG. 4 illustrates mode estimation of the first embodiment.

FIG. 5 is a flowchart depicting a specific control of the first embodiment.

### DESCRIPTION OF EMBODIMENTS

Hereinbelow, embodiments of the present invention will be described with reference to the drawings. Meanwhile, in the embodiments below, the same or equivalent parts are denoted with the same references in the drawings. Also, the second and third embodiments will be described with reference to the description and drawings of the first embodiment.

### First Embodiment

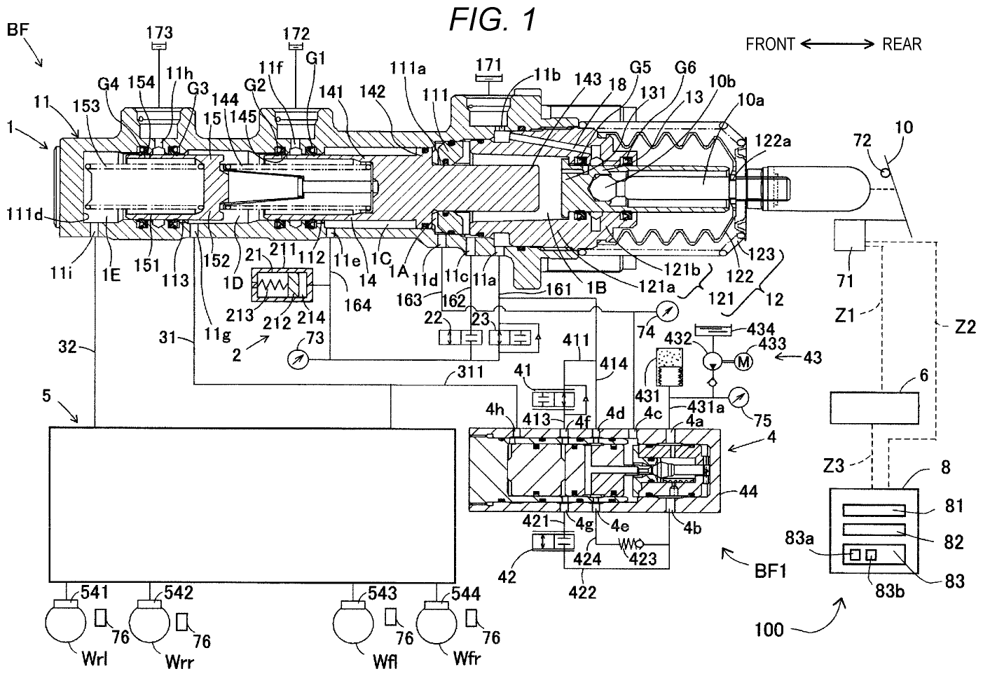

As shown in FIG. 1, a brake device for a vehicle includes a hydraulic braking force generating device BF, a first control unit 6, and a second control unit 8. The first control unit 6 and the second control unit 8 configure a brake control device 100. The hydraulic braking force generating device BF includes a master cylinder 1, a reactive force generating device 2, a first control valve 22, a second control valve 23, a servo pressure generating device (force multiplier) 4, an actuator (corresponding to “second pressurizing mechanism”) 5, wheel cylinders 541 to 544, and various types of sensors 71 to 77.

The master cylinder 1, the first control valve 22, the second control valve 23, and the servo pressure generating device 4 configure an upstream side pressurizing mechanism (corresponding to “first pressurizing mechanism”) BF1, which is a (master pressure) pressurizing mechanism on an upstream side. The actuator 5 configures a downstream side pressurizing mechanism, which is a (wheel pressure) pressurizing mechanism on a downstream side. That is, the hydraulic braking force generating device BF includes the upstream side pressurizing mechanism BF1, and the actuator 5, which is the downstream side pressurizing mechanism.

The master cylinder 1 is a part configured to supply an operating fluid to the actuator 5, in correspondence to an operation amount on a brake pedal (corresponding to “brake operating member”) 10, and is configured by a main cylinder 11, a cover cylinder 12, an input piston 13, a first master piston 14, a second master piston 15, and the like. The brake pedal 10 may be any brake operating means with which a driver can perform a brake operation.

The main cylinder 11 is a substantially cylindrical bottomed housing of which a front side is closed and a rear side is opened. An inner wall part 111 protruding in an inward flange shape is provided in the vicinity of the rear of an inner periphery side of the main cylinder 11. A center of the inner wall part 111 is formed as a through-hole 111a penetrating in a front and rear direction. Also, small-diameter portions 112 (rear) and 113 (front) having slightly smaller inner diameters are provided ahead of the inner wall part 111 in the main cylinder 11. That is, the small-diameter portions 112 and 113 protrude annularly inward from an inner peripheral surface of the main cylinder 11. In the main cylinder 11, the first master piston 14 is disposed to be axially movable with being in sliding contact with the small-diameter portion 112. Likewise, the second master piston 15 is disposed to be axially movable with being in sliding contact with the small-diameter portion 113.

The cover cylinder 12 is configured by a substantially cylindrical cylinder part 121, a boot 122 having a bellows tube shape, and a cup-shaped compression spring 123. The cylinder part 121 is dispose on a rear end side of the main cylinder 11, and is coaxially fitted to an opening on a rear side of the main cylinder 11. An inner diameter of a front portion 121a of the cylinder part 121 is greater than an inner diameter of the through-hole 111a of the inner wall part 111. Also, an inner diameter of a rear portion 121b of the cylinder part 121 is smaller than the inner diameter of the front portion 121a.

The dust-proof boot 12 can be expanded and contracted in a bellows tube shape in the front and rear direction, and is attached so as to contact an opening on a rear end side of the cylinder part 121 on a front side thereof. A rear center of the boot 122 is formed with a through-hole 122a. The compression spring 123 is a coil-shaped urging member disposed around the boot 122, and a diameter thereof is reduced so that a front side thereof is in contact with a rear end of the main cylinder 11 and a rear side thereof is close to the through-hole 122a of the boot 122. A rear end of the boot 122 and a rear end of the compression spring 123 are coupled to an operating rod 10a. The compression spring 123 urges the operating rod 10a rearward.

The input piston 13 is a piston configured to slide in the cover cylinder 12, in correspondence to an operation on the brake pedal 10. The input piston 13 is a substantially cylindrical bottomed piston having a bottom at the front and an opening at the rear. A bottom wall 131 configuring the bottom of the input piston 13 has a diameter greater than the other part of the input piston 13. The input piston 13 is liquid-tightly disposed in the rear portion 121b of the cylinder part 121 so as to be axially slidable, and the bottom wall 131 is located on an inner periphery side of the front portion 121a of the cylinder part 121.

In the input piston 13, the operating rod 10a configured to operate in conjunction with the brake pedal 10 is disposed. A pivot 10b at a tip of the operating rod 10a can push forward the input piston 13. A rear end of the operating rod 10a protrudes outward through the opening on the rear side of the input piston 13 and the through-hole 122a of the boot 122, and is connected to the brake pedal 10. When the brake pedal 10 is stepped, the operating rod 10a is advanced forward while pushing axially the boot 122 and the compression spring 123. As the operating rod 10a is advanced forward, the input piston 13 is also advanced forward.

The first master piston 14 is disposed on the inner wall part 111 of the main cylinder 11 so as to be axially slidable. The first master piston 14 has a pressurizing tubular part 141, a flange part 142, and a protrusion 143, which are integrally formed in corresponding order from the front. The pressurizing tubular part 141 is formed to have a substantially cylindrical bottomed shape having an opening at the front, has a gap from the inner peripheral surface of the main cylinder 11, and is in sliding contact with the small-diameter portion 112. In an internal space of the pressurizing tubular part 141, a coil spring-shaped urging member 144 is disposed between the second master piston 15 and the pressurizing tubular part 141. The first master piston 14 is urged rearward by the urging member 144. In other words, the first master piston 14 is urged toward a set initial position by the urging member 144.

The flange part 142 has a diameter greater than the pressurizing tubular part 141, and is in sliding contact with the inner peripheral surface of the main cylinder 11. The protrusion 143 has a diameter smaller than the flange part 142, and is disposed in the through-hole 111a of the inner wall part 111 so as to be air-tightly slidable. A rear end of the protrusion 143 protrudes into the internal space of the cylinder part 121 through the through-hole 111a, and is spaced from the inner peripheral surface of the cylinder part 121. A rear end face of the protrusion 143 is spaced from the bottom wall 131 of the input piston 13, and a spacing distance thereof can be varied.

Herein, a “first master chamber 1D” is demarcated by the inner peripheral surface of the main cylinder 11, a front side of the pressurizing tubular part 141 of the first master piston 14, and a rear side of the second master piston 15. Also, a rear chamber is demarcated at the rear of the first master chamber 1D by the inner peripheral surface (inner peripheral part) of the main cylinder 11, the small-diameter portion 112, a front surface of the inner wall part 111, and an outer peripheral surface of the first master piston 14. A front end portion and a rear end portion of the flange part 142 of the first master piston 14 divide the rear chamber in the front and rear direction, so that a “second hydraulic pressure chamber 1C” is demarcated on the front side and a “servo chamber 1A” is demarcated on the rear side. A volume of the second hydraulic pressure chamber 1C decreases as the first master piston 14 is advanced forward, and increases as the first master piston 14 is retreated. Also, a “first hydraulic pressure chamber 1B” is demarcated by the inner peripheral part of the main cylinder 11, a rear surface of the inner wall part 111, an inner peripheral surface (inner peripheral part) of the front portion 121a of the cylinder part 121, the protrusion 143 (rear end portion) of the first master piston 14, and the front end portion of the input piston 13.

The second master piston 15 is disposed on the front side of the first master piston 14 in the main cylinder 11 so as to be axially movable with being in sliding contact with the small-diameter portion 113. The second master piston 15 has a cylindrical pressurizing tubular part 151 having an opening at the front, and a bottom wall 152 formed to close a rear side of the pressurizing tubular part 151, which are integrally formed. The bottom wall 152 is configured to support the urging member 144 between the bottom wall and the first master piston 14. In an internal space of the pressurizing tubular part 151, a coil spring-shaped urging member 153 is disposed between the pressurizing tubular part 151 and a closed inner bottom surface 111d of the main cylinder 11. The second master piston 15 is urged rearward by the urging member 153. In other words, the second master piston 15 is urged toward the set initial position by the urging member 153. A “second master chamber 1E” is demarcated by the inner peripheral surface of the main cylinder 11, the inner bottom surface 111d, and the second master piston 15.

The master cylinder 1 is formed with ports 11a to 11i configured to communicate an inside and an outside each other. The port 11a is formed at the rear of the inner wall part 111 of the main cylinder 11. The port 11b is formed to face the port 11a, in an axial position similar to the port 11a. The port 11a and the port 11b are formed to communicate with each other via an annular space between the inner peripheral surface of the main cylinder 11 and an outer peripheral surface of the cylinder part 121. The port 11a and the port 11b are connected to a pipe 161 and a reservoir 171 (lower pressure source).

Also, the port 11b is formed to communicate with the first hydraulic pressure chamber 1B by a passage 18 formed in the cylinder part 121 and the input piston 13. The passage 18 is blocked when the input piston 13 is advanced forward, so that the first hydraulic pressure chamber 1B and the reservoir 171 are blocked from each other. The port 11c is formed at the rear of the inner wall part 111 and in front of the port 11a, and is configured to communicate the first hydraulic pressure chamber 1B and a pipe 162 each other. The port 11d is formed in front of the port 11c, and is configured to communicate the servo chamber 1A and a pipe 163 each other. The port 11e is formed in front of the port 11d, and is configured to communicate the second hydraulic pressure chamber 1C and a pipe 164 each other.

The port 11f is formed between both seal members G1 and G2 of the small-diameter portion 112, and is configured to communicate a reservoir 172 and the inside of the main cylinder 11 each other. The port 11f is formed to communicate with the first master chamber 1D via a passage 145 formed in the first master piston 14. The passage 145 is formed in a position in which the port 11f and the first master chamber 1D are blocked when the first master piston 14 is advanced forward. The port 11g is formed in front of the port 11f, and is configured to communicate the first master chamber 1D and a pipe path 31 each other.

The port 11h is formed between both seal members G3 and G4 of the small-diameter portion 113, and is configured to communicate a reservoir 173 and the inside of the main cylinder 11 each other. The port 11h is formed to communicate with the second master chamber 1E via a passage 154 formed in the pressurizing tubular part 151 of the second master piston 15. The passage 154 is formed in a position in which the port 11h and the second master chamber 1E are blocked when the second master piston 15 is advanced forward. The port 11i is formed in front of the port 11h, and is configured to communicate the second master chamber 1E and a pipe path 32 each other.

Also, a seal member such as an O-ring is appropriately disposed in the master cylinder 1. The seal members G1 and G2 are disposed on the small-diameter portion 112, and are in contact with the outer peripheral surface of the first master piston 14 in a liquid-tight manner. Likewise, the seal members G3 and G4 are disposed on the small-diameter portion 113, and are in contact with the outer peripheral surface of the second master piston 15 in a liquid-tight manner. Also, seal members G5 and G6 are disposed between the input piston 13 and the cylinder part 121.

A stroke sensor 71 is a sensor configured to detect an operation amount (stroke) of the brake pedal 10 operated by the driver, and is configured to transmit a detection signal to the first control unit 6 and the second control unit 8. A brake stop switch 72 is a switch configured to detect whether the brake pedal 10 is operated by the driver with a binary signal, and is configured to transmit a detection signal to the first control unit 6.

The reactive force generating device 2 is a device that, when the brake pedal 10 is operated, generates reactive force against the operating force, and is mainly configured by a stroke simulator 21. The stroke simulator 21 is configured to generate a reactive force hydraulic pressure in the first hydraulic pressure chamber 1B and the second hydraulic pressure chamber 1C, in correspondence to an operation on the brake pedal 10. The stroke simulator 21 has a piston 212 slidably fitted to a cylinder 211. The piston 212 is urged rearward by a compression spring 213, and a reactive force hydraulic pressure chamber 214 is formed on a rear surface side of the piston 212. The reactive force hydraulic pressure chamber 214 is connected to the second hydraulic pressure chamber 1C via the pipe 164 and the port 11e, and is connected to the first control valve 22 and the second control valve 23 via the pipe 164.

The first control valve 22 is an electromagnetic valve configured to be closed in a non-energization state, and opening and closing thereof is controlled by the first control unit 6. The first control valve 22 is connected between the pipe 164 and the pipe 162. Herein, the pipe 164 communicates with the second hydraulic pressure chamber 1C via the port 11e, and the pipe 162 communicates with the first hydraulic pressure chamber 1B via the port 11c. Also, when the first control valve 22 is opened, the first hydraulic pressure chamber 1B is opened, and when the first control valve 22 is closed, the first hydraulic pressure chamber 1B is sealed. Therefore, the pipe 164 and the pipe 162 are provided to communicate the first hydraulic pressure chamber 1B and the second hydraulic pressure chamber 1C each other.

The first control valve 22 is closed in a non-energization state, in which the first hydraulic pressure chamber 1B and the second hydraulic pressure chamber 1C are blocked each other. Thereby, the first hydraulic pressure chamber 1B is sealed, so that there is no place for the operating fluid and the input piston 13 and the first master piston 14 operate in cooperation with each other while keeping a constant distance therebetween. Also, the first control valve 22 is opened in an energization state, in which the first hydraulic pressure chamber 1B and the second hydraulic pressure chamber 1C communicate with each other. Thereby, a change in volumes of the first hydraulic pressure chamber 1B and the second hydraulic pressure chamber 1C as a result of the advance and retreat of the first master piston 14 is absorbed by movement of the operating fluid.

A pressure sensor 73 is a sensor configured to detect reactive force hydraulic pressures in the second hydraulic pressure chamber 1C and the first hydraulic pressure chamber 1B, and is connected to the pipe 164. The pressure sensor 73 detects the pressure in the second hydraulic pressure chamber 1C when the first control valve 22 is closed, and also detects the pressure in the first hydraulic pressure chamber 1B in a communication state when the first control valve 22 is opened. The pressure sensor 73 is configured to transmit a detection signal to the first control unit 6.

The second control valve 23 is an electromagnetic valve configured to open in a non-energization state, and opening and closing thereof are controlled by the first control unit 6. The second control valve 23 is connected between the pipe 164 and the pipe 161. Herein, the pipe 164 communicates with the second hydraulic pressure chamber 1C via the port 11e, and the pipe 161 communicates with the reservoir 171 via the port 11a. Therefore, the second control valve 23 is configured to communicate the second hydraulic pressure chamber 1C and the reservoir 171 each other and not to generate the reactive force hydraulic pressure in the non-energization state, and to block the second hydraulic pressure chamber 1C and the reservoir 171 each other and to generate the reactive force hydraulic pressure in the energization state.

The servo pressure generating device 4 includes a pressure reducing valve 41, a booster valve 42, a pressure supply part 43, a regulator 44, and the like. The pressure reducing valve 41 is a normally open electromagnetic valve (normally open valve) configured to open in the non-energization state, and a flow rate (or pressure) thereof is controlled by the first control unit 6. One side of the pressure reducing valve 41 is connected to the pipe 161 via a pipe 411, and the other side of the pressure reducing valve 41 is connected to a pipe 413. That is, one side of the pressure reducing valve 41 communicates with the reservoir 171 via the pipes 411 and 161 and the ports 11a and 11b. When the pressure reducing valve 41 is closed, the operating fluid is prevented from flowing out from a first pilot chamber 4D, which will be described later. In the meantime, although not shown, the reservoir 171 and a reservoir 434 are configured to communicate with each other. The reservoir 171 and the reservoir 434 may be the same reservoirs.

The booster valve 42 is a normally closed electromagnetic valve (normally closed valve) configured to close in the non-energization state, and a flow rate (or pressure) thereof is controlled by the first control unit 6. One side of the booster valve 42 is connected to a pipe 421, and the other side of the booster valve 42 is connected to a pipe 422. The pressure supply part 43 is a part configured to supply a high-pressure operating fluid to the regulator 44. The pressure supply part 43 includes an accumulator (high pressure source) 431, a hydraulic pump 432, a motor 433, the reservoir 434, and the like.

The accumulator 431 is a tank configured to accumulate therein a high-pressure operating fluid. The accumulator 431 is connected to the regulator 44 and the hydraulic pump 432 by a pipe 431a. The hydraulic pump 432 is configured to drive by the motor 433, thereby pneumatically transporting the operating fluid stored in the reservoir 434 to the accumulator 431. A pressure sensor 75 provided to the pipe 431a is configured to detect an accumulator hydraulic pressure in the accumulator 431, and to transmit a detection signal to the first control unit 6. The accumulator hydraulic pressure correlates with an amount of accumulation of the operating fluid accumulated in the accumulator 431.

When the pressure sensor 75 detects that the accumulator hydraulic pressure is lowered to a predetermined value or smaller, the motor 433 is driven, based on a command from the first control unit 6. Thereby, the hydraulic pump 432 pneumatically transports the operating fluid to the accumulator 431, thereby recovering the accumulator hydraulic pressure to the predetermined value or greater.

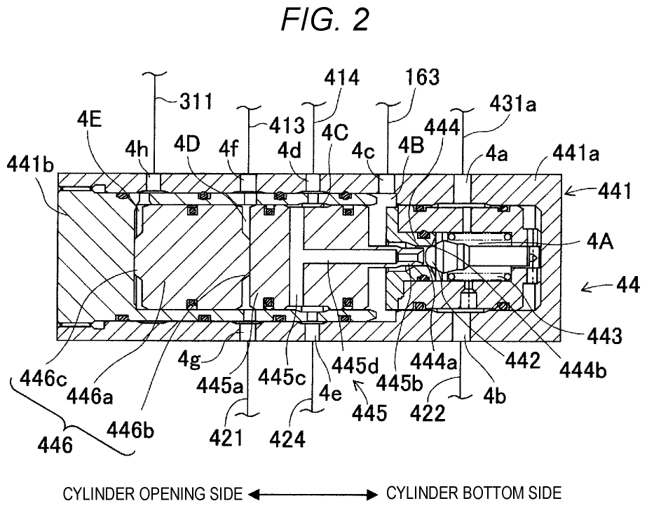

As shown in FIG. 2, the regulator 44 includes a cylinder 441, a ball valve 442, an urging part 443, a valve seat part 444, a control piston 445, a sub-piston 446 and the like. The cylinder 441 is configured by a substantially cylindrical bottomed cylinder case 441a having a bottom on one side (a right side in FIG. 2), and a cover member 441b configured to block an opening (a left side in FIG. 2) of the cylinder case 441a. The cylinder case 441a is formed with a plurality of ports 4a to 4h for communicating an inside and an outside. The cover member 441b has also a substantially cylindrical bottomed shape, and is formed with respective ports at respective portions facing the plurality of ports 4a to 4h.

The port 4a is connected to the pipe 431a. The port 4b is connected to the pipe 422. The port 4c is connected to the pipe 163. The pipe 163 interconnects the servo chamber 1A and the port 4c. The port 4d is connected to the reservoir 434 via a pipe 414. The port 4e is connected to a pipe 424, and is also connected to the pipe 422 via a relief valve 423. The port 4f is connected to the pipe 413. The port 4g is connected to the pipe 421. The port 4h is connected to a pipe path 311 branched from the pipe path 31.

The ball valve 442 is a ball-type valve and is disposed on a bottom side (hereinbelow, also referred to as ‘cylinder bottom side’) of the cylinder case 441a in the cylinder 441. The urging part 443 is a spring member for urging the ball valve 442 toward an opening side of the cylinder case 441a (hereinbelow, also referred to as ‘cylinder opening side’), and is provided on the bottom of the cylinder case 441a. The valve seat part 444 is a wall member provided on an inner peripheral surface of the cylinder case 441a, and demarcates the cylinder opening side and the cylinder bottom side. A center of the valve seat part 444 is formed with a through-path 444a for communicating the demarcated cylinder opening side and cylinder bottom side each other. The valve seat part 444 is configured to hold the ball valve 442 from the cylinder opening side, in such an aspect that the urged ball valve 442 cuts off the through-path 444a. The through-path 444a is formed at an opening portion on the cylinder bottom side with a valve seat surface 444b on which the ball valve 442 is separably seated (contacted).

A space demarcated by the ball valve 442, the urging part 443, the valve seat part 444, and the inner peripheral surface of the cylinder case 441a of the cylinder bottom side is referred to as “first chamber 4A”. The first chamber 4A is filled with the operating fluid, and is connected to the pipe 431a via the port 4a and to the pipe 422 via the port 4b.

The control piston 445 is configured by a main body part 445a having a substantially circular cylinder shape, and a protrusion 445b having a substantially circular cylinder shape of which a diameter is smaller than the main body part 445a. The main body part 445a is coaxially and liquid-tightly disposed on the cylinder opening side of the valve seat part 444 so as to be axially slidable in the cylinder 441. The main body part 445a is urged toward the cylinder opening side by an urging member (not shown). The main body part 445a is formed at a substantial center in an axial direction of the cylinder with a passage 445c extending in a radial direction (vertical direction in FIG. 2) and having both ends opened to a circumferential surface of the main body part 445a. A partial inner peripheral surface of the cylinder 441 corresponding to the opening position of the passage 445c is formed with the port 4d and is formed concave. This concave space is referred to as “third chamber 4C”.

The protrusion 445b protrudes toward the cylinder bottom side from a center of the cylinder bottom side end face of the main body part 445a. A diameter of the protrusion 445b is smaller than the through-path 444a of the valve seat part 444. The protrusion 445b is disposed on the same axis as the through-path 444a. A tip of the protrusion 445b is spaced from the ball valve 442 toward the cylinder opening side by a predetermined interval. The protrusion 445b is formed with a passage 445d opened to a center of the cylinder bottom side end face of the protrusion 445b and extending in the axial direction of the cylinder. The passage 445d extends into the main body part 445a, and connects to the passage 445c.

A space demarcated by the cylinder bottom side end face of the main body part 445a, an outer peripheral surface of the protrusion 445b, an inner peripheral surface of the cylinder 441, the valve seat part 444, and the ball valve 442 is referred to as “second chamber 4B”. The second chamber 4B is formed to communicate with the ports 4d and 4e via the passages 445d and 445c and the third chamber 4C in a state in which the protrusion 445b and the ball valve 442 are not contacted.

The sub-piston 446 is configured by a sub-main body part 446a, a first protrusion 446b, and a second protrusion 446c. The sub-main body part 446a has a substantial circular cylinder shape. The sub-main body part 446a is coaxially and liquid-tightly disposed on the cylinder opening side of the main body part 445a so as to be axially slidable in the cylinder 441. Also, an end portion on the cylinder bottom side of the sub-piston 446 may be provided with a damper mechanism.

The first protrusion 446b has a substantially circular cylinder shape having a diameter smaller than the sub-main body part 446a, and protrudes from a center of the cylinder bottom side end face of the sub-main body part 446a. The first protrusion 446b is in contact with the cylinder opening side end face of the main body part 445a. The second protrusion 446c has the same shape as the first protrusion 446b, and protrudes from a center of the cylinder opening side end face of the sub-main body part 446a. The second protrusion 446c is in contact with the cover member 441b.

A space demarcated by the cylinder bottom side end face of the sub-main body part 446a, an outer peripheral surface of the first protrusion 446b, the cylinder opening side end face of the control piston 445, and the inner peripheral surface of the cylinder 441 is referred to as “first pilot chamber 4D”. The first pilot chamber 4D is formed to communicate with the pressure reducing valve 41 via the port 4f and the pipe 413, and to communicate with the booster valve 42 via the port 4g and the pipe 421.

In the meantime, a space demarcated by the cylinder opening side end face of the sub-main body part 446a, the outer peripheral surface of the second protrusion 446c, the cover member 441b, and the inner peripheral surface of the cylinder 441 is referred to as “second pilot chamber 4E”. The second pilot chamber 4E is formed to communicate with the port 11g via the port 4h and the pipe paths 311 and 31. Each of the chambers 4A to 4E is filled with the operating fluid. A pressure sensor 74 is a sensor configured to detect a servo pressure to be supplied to the servo chamber LA, and is connected to the pipe 163. The pressure sensor 74 is configured to transmit a detection signal to the first control unit 6.

The regulator 44 has the control piston 445 configured to drive by a difference between force corresponding to a pressure in the first pilot chamber 4D (also referred to as “pilot pressure”) and force corresponding to the servo pressure. When a volume of the first pilot chamber 4D changes and a flow rate of liquid to flow in/out with respect to the first pilot chamber 4D increases as the control piston 445 moves, an amount of movement of the control piston 445 on the basis of a position of the control piston 445 in an equilibrium state in which the force corresponding to the pilot pressure and the force corresponding to the servo pressure are balanced increases, so that the flow rate of the liquid to flow in/out with respect to the servo chamber LA increases. That is, the regulator 44 is configured so that the liquid of a flow rate corresponding to the differential pressure between the pilot pressure and the servo pressure is to flow in/out with respect to the servo chamber LA.

The actuator 5 is disposed between the first master chamber 1D and the second master chamber 1E, in which the master pressure is to be generated, and wheel cylinders 541 to 544. The actuator 5 and the first master chamber 1D are interconnected by the pipe path 31, the actuator 5 and the second master chamber 1E are interconnected by the pipe path 32. The actuator 5 is a device configured to adjust hydraulic pressures (wheel pressures) of the wheel cylinders 541 to 544, in accordance with an instruction of the second control unit 8. The actuator 5 is configured to execute a pressurizing control of further pressurizing the brake fluid from the master pressure, a pressure reducing control, and a holding control, in accordance with an instruction of the second control unit 8. The actuator 5 is configured to execute an antiskid control (ABS control), a skid preventing control (ESC control) or the like by combining the controls.

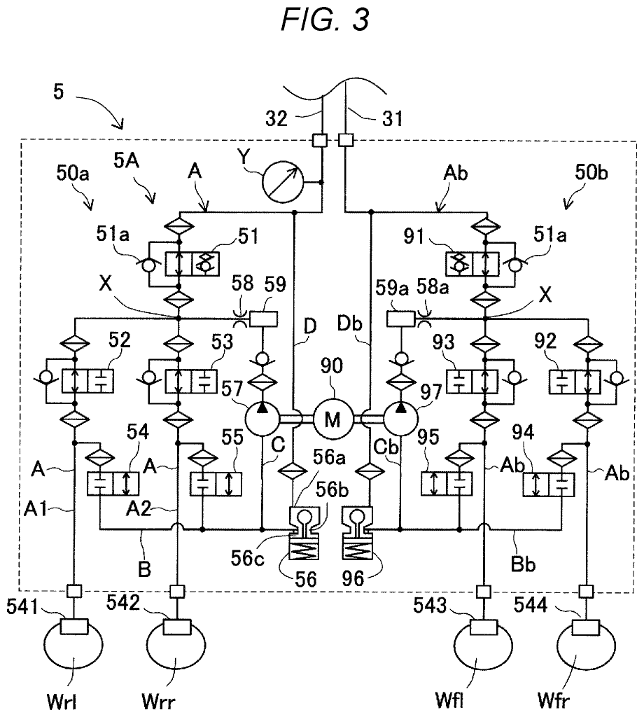

Specifically, as shown in FIG. 3, the actuator 5 includes a hydraulic circuit 5A, and a motor 90. The hydraulic circuit 5A includes a first pipe system 50a, and a second pipe system 50b. The first pipe system 50a is a system configured to control hydraulic pressures (wheel pressures) to be applied to rear wheels Wrl and Wrr. The second pipe system 50b is a system configured to control hydraulic pressures (wheel pressures) to be applied to front wheels Wfl and Wfr. Also, each of the wheels W is provided with a wheel speed sensor 76. In the first embodiment, a front and rear pipe is adopted.

The first pipe system 50a includes a main pipe path A, a differential pressure control valve 51, booster valves 52 and 53, a pressure reducing pipe path B, pressure reducing valves 54 and 55, a pressure-adjusting reservoir 56, a recirculation pipe path C, a pump 57, an auxiliary pipe path D, an orifice part 58, and a damper part 59. Herein, the term “pipe path” can be replaced with a hydraulic pressure path, a flow path, an oil path, a passage, a pipe or the like.

The main pipe path A is a pipe path configured to interconnect the pipe path 32 and the wheel cylinders 541 and 5424. The differential pressure control valve 51 is an electromagnetic valve provided on the main pipe path A and configured to control the main pipe path A to a communication state and a differential pressure state. The differential pressure state is a state in which a flow path is limited by a valve, and can be said as a throttled state. The differential pressure control valve 51 is configured to control a differential pressure (hereinbelow, also referred to as “first differential pressure”) between the hydraulic pressure on the master cylinder 1-side and the hydraulic pressure on the wheel cylinders 541 and 542-side, setting itself as a center, in correspondence to control current based on an instruction of the second control unit 8. In other words, the differential pressure control valve 51 is configured to control the differential pressure between the hydraulic pressure of apart of the main pipe path A on the master cylinder 1-side and the hydraulic pressure of a part of the main pipe path A on the wheel cylinders 541 and 542-side.

The differential pressure control valve 51 is a normally open type that is to be in a communication state in the non-energization state. The higher the control current to be applied to the differential pressure control valve 51 is, the higher the first differential pressure is. When the differential pressure control valve 51 is controlled to the differential pressure state and the pump 57 is thus driven, the hydraulic pressure on the wheel cylinders 541 and 542-side becomes higher than the hydraulic pressure on the master cylinder 1-side, in correspondence to the control current. The differential pressure control valve 51 is provided with a check valve 51a. The main pipe path A is bifurcated to two pipe paths A1 and A2 at a bifurcation point X downstream of the differential pressure control valve 51, so as to correspond to the wheel cylinders 541 and 542.

The booster valves 52 and 53 are electromagnetic valves to be opened and closed by an instruction of the second control unit 8, and are normally open electromagnetic valves that are in an open state (communication state) in the non-energization state. The booster valve 52 is disposed on the pipe path A1, and the booster valve 53 is disposed on the pipe path A2. The booster valves 52 and 53 are opened in the non-energization state to communicate the wheel cylinders 541 to 544 and the bifurcation point X during the booster control, and are energized and closed to cut off the wheel cylinder 541 to 544 and the bifurcation point X during the holding control and the pressure reducing control.

The pressure reducing pipe path B is a pipe path configured to interconnect a point between the booster valve 52 and the wheel cylinders 541 and 542 on the pipe path A1 and the pressure-adjusting reservoir 56 each other and to interconnect a point between the booster valve 53 and the wheel cylinders 541 and 542 on the pipe path A2 and the pressure-adjusting reservoir 56 each other. The pressure reducing valves 54 and 55 are electromagnetic valves to be opened and closed by an instruction of the second control unit 8, and are normally closed electromagnetic valves that are in a closed state (cutoff state) in the non-energization state. The pressure reducing valve 54 is disposed on the pressure reducing pipe path B on the wheel cylinders 541 and 542-side. The pressure reducing valve 55 is disposed on the pressure reducing pipe path B on the wheel cylinders 541 and 542-side. The pressure reducing valves 54 and 55 are energized and opened during the pressure reducing control, thereby communicating the wheel cylinders 541 and 542 and the pressure-adjusting reservoir 56 each other via the pressure reducing pipe path B. The pressure-adjusting reservoir 56 is a reservoir including a cylinder, a piston, and an urging member.

The recirculation pipe path C is a pipe path configured to interconnect the pressure reducing pipe path B (or the pressure-adjusting reservoir 56) and a point between the differential pressure control valve 51 and the booster valves 52 and 53 (here, the bifurcation point X) on the main pipe path A. The pump 57 is provided on the recirculation pipe path C so that a discharge port thereof is disposed on the bifurcation point X-side and a suction port thereof is disposed on the pressure-adjusting reservoir 56-side. The pump 57 is a piston-type electric pump that is to be driven by the motor 90. The pump 57 is configured to cause the brake fluid to flow from the pressure-adjusting reservoir 56 toward the master cylinder 1 or the wheel cylinders 541 and 542 via the recirculation pipe path C.

The pump 57 is configured to repeat a discharge process of discharging the brake fluid and a suction process of sucking the brake fluid. That is, when the pump 57 is driven by the motor 90, the pump 57 alternately repeats the discharge process and the suction process. In the discharge process, the brake fluid sucked from the pressure-adjusting reservoir 56 in the suction process is supplied to the bifurcation point X. The motor 90 is energized and driven via a relay (not shown) by an instruction of the second control unit 8. The pump 57 and the motor 90 may be collectively said as an electric pump.

The orifice part 58 is a throttle-shaped part (so-called orifice) provided on a part between the pump 57 and the bifurcation point X on the recirculation pipe path C. The damper part 59 is a damper (damper mechanism) connected between the pump 57 and the orifice part 58 on the recirculation pipe path C. The damper part 59 is configured to suck/discharge the brake fluid, in correspondence to pulsation of the brake fluid in the recirculation pipe path C. The orifice part 58 and the damper part 59 can be said as a pulsation reducing mechanism for reducing (attenuating, absorbing) the pulsation.

The auxiliary pipe path D is a pipe path configured to interconnect a pressure-adjusting hole 56a of the pressure-adjusting reservoir 56 and a side (or the master cylinder 1) of the main pipe path A upstream of the differential pressure control valve 51. The pressure-adjusting reservoir 56 is configured so that a valve hole 56b is to be closed as an inflow amount of the brake fluid into the pressure-adjusting hole 56a increases as a stroke increases. Aside of the valve hole 56b facing toward the pipe paths B and C is formed with a reservoir chamber 56c.

As the pump 57 is driven, the brake fluid in the pressure-adjusting reservoir 56 or the master cylinder 1 is discharged to the part (the bifurcation point X) between the differential pressure control valve 51 and the booster valves 52 and 53 on the main pipe path A, via the recirculation pipe path C. Then, the wheel pressure is pressurized, in correspondence to the control states of the differential pressure control valve 51 and the booster valves 52 and 53. Like this, in the actuator 5, the pressurizing control is executed by the drive of the pump 57 and the control on the various valves. That is, the actuator 5 is configured to be able to pressurize the wheel pressure. In the meantime, apart of the main pipe path A between the differential pressure control valve 51 and the master cylinder 1 is provided with a pressure sensor Y configured to detect a hydraulic pressure (master pressure) of the part. The pressure sensor Y is configured to transmit a detection result to the first control unit 6 and the second control unit 8.

The second pipe system 50b is a system having a similar configuration to the first pipe system 50a, and configured to adjust hydraulic pressures of the wheel cylinders 543 and 544 for the front wheels Wfl and Wfr. The second pipe system 50b includes a main pipe path Ab corresponding to the main pipe path A. and configured to interconnect the pipe path 31 and the wheel cylinder 543 and 544, a differential pressure control valve 91 corresponding to the differential pressure control valve 51, booster valves 92 and 93 corresponding to the booster valves 52 and 53, a pressure reducing pipe path Bb corresponding to the pressure reducing pipe path B, pressure reducing valves 94 and 95 corresponding to the pressure reducing valves 54 and 55, a pressure-adjusting reservoir 96 corresponding to the pressure-adjusting reservoir 56, a recirculation pipe path Cb corresponding to the recirculation pipe path C, a pump 97 corresponding to the pump 57, an auxiliary pipe path Db corresponding to the auxiliary pipe path D, an orifice part 58a corresponding to the orifice part 58, and a damper part 59a corresponding to the damper part 59. The description of the detailed configuration of the second pipe system 50b is omitted because the description of the first pipe system 50a can be referred to.

The wheel pressure adjusting by the actuator 5 is performed by executing the booster control of providing the master pressure to the wheel cylinders 541 to 544, as it is, the holding control of sealing the wheel cylinders 541 to 544, the pressure reducing control of causing the fluid in the wheel cylinders 541 to 544 to flow out to the pressure-adjusting reservoir 56, or the pressurizing control of pressurizing the wheel pressure through the throttling by the differential pressure control valve 51 and through the drive of the pump 57.

The first control unit 6 and the second control unit 8 are electronic control units (ECUs) each of which has a CPU, a memory and the like. The first control unit 6 is an ECU configured to execute a control on the servo pressure generating device 4, based on a target wheel pressure (or a target deceleration) that is a target value of the wheel pressure. The first control unit 6 is configured to execute the pressurizing control, the pressure reducing control, or the holding control on the servo pressure generating device 4, based on the target wheel pressure. In the pressurizing control, the booster valve 42 is opened and the pressure reducing valve 41 is closed. In the pressure reducing control, the booster valve 42 is closed, and the pressure reducing valve 41 is opened. In the holding control, the booster valve 42 and the pressure reducing valve 41 are closed.

To the first control unit 6, a variety of sensors such as the stroke sensor 71, the pressure sensors Y, 25b, 26a and 15b5, and the wheel speed sensor 76 are connected. The first control unit 6 is configured to acquire stroke information, master pressure information, reactive force hydraulic pressure information, servo pressure information, wheel speed information and the like from the sensors. The sensors and the first control unit 6 are interconnected by a communication line (CAN) (not shown).

The second control unit 8 is an ECU configured to execute control on the actuator 5, based on a target wheel pressure (or a target deceleration) that is a target value of the wheel pressure. The second control unit 8 is configured to execute the booster control, the pressure reducing control, the holding control, or the pressurizing control on the actuator 5, based on the target wheel pressure, as described above.

Herein, each control state by the second control unit 8 is briefly described by taking a control on the wheel cylinder 541 as an example. In the booster control, the differential pressure control valve 51 and the booster valve 52 are opened, and the pressure reducing valve 54 is closed. In the pressure reducing control, the booster valve 52 is closed, and the pressure reducing valve 54 is opened. In the holding control, the booster valve 52 and the pressure reducing valve 54 are closed. In the pressurizing control, the differential pressure control valve 51 is in the differential pressure state (throttled state), the booster valve 52 is opened, the pressure reducing valve 54 is closed, and the pump 57 is driven.

To the second control unit 8, various types of sensors such as the stroke sensor 71, the pressure sensors Y and 25b, and the wheel speed sensor 76 are connected. The second control unit 8 is configured to acquire stroke information, master pressure information, reactive force hydraulic pressure information, and wheel speed information from the sensors. The sensors and the second control unit 8 are interconnected by a communication line (not shown). The second control unit 8 is configured to execute a skid preventing control or ABS control on the actuator 5, in correspondence to a situation and a request. Also, the second control unit 8 is communicatively connected to the first control unit 6 by the communication line. Meanwhile, in the first embodiment, the stroke sensor 71 and the second control unit 8 are interconnected by a communication line Z1, the stroke sensor 71 and the first control unit 6 are interconnected by a communication line Z2, and the second control unit 8 and the first control unit 6 are interconnected by a communication line Z3. The other communication lines are not shown in the drawings.

Briefly describing a cooperative control, the first control unit 6 sets a target deceleration, based on the stroke information, and transmits the target deceleration information (corresponding to “control information”) to the second control unit 8 via the communication line Z3. A target master pressure and a target wheel pressure are determined on the basis of the target deceleration. The first control unit 6 and the second control unit 8 control the hydraulic pressure of the brake fluid by the cooperative control so that the wheel pressure is to approximate to the target wheel pressure (the deceleration is to approximate to the target deceleration). The first control unit 6 calculates the target deceleration to calculate the target master pressure on the basis of the stroke, and the second control unit 8 calculates the target wheel pressure on the basis of the target deceleration, and sets a pressurizing amount (control amount), based on the detected master pressure and the target wheel pressure.

Herein, a pressurizing mode of the upstream side pressurizing mechanism BF1 is described. In the upstream side pressurizing mechanism BF1, a plurality of (here, three) pressurizing modes is set. In the upstream side pressurizing mechanism BF1, a linear mode, a regulator mode, and a static pressure mode (a mode upon a failure of the accumulator 431) are set as the pressurizing mode, in terms of configuration. The linear mode is a normal mode. For example, during the pressurizing control, the booster valve 42 is opened, so that the servo pressure is increased via the regulator 44, and the master pressure is increased, as described above.

The regulator mode is a mode that is to be mainly executed upon a failure of an electric system. In the regulator mode, the first control valve 22 is closed to seal the first hydraulic pressure chamber 1B and the second control valve 23 is opened to communicate the second hydraulic pressure chamber 1C and the reservoir 171 each other by the non-energization state. Thereby, an invalid stroke is canceled, the reactive force hydraulic pressure becomes an atmospheric pressure, and a driver's operation on the brake pedal 10 can be easily transmitted to the master pistons 14 and 15. That is, the master pressure is likely to be associated with the brake operation. Also, in the regulator mode, the brake fluid is enabled to flow from the second master chamber 1E into the second pilot chamber 4E of the regulator 44 via the pipe paths 31 and 311 and the port 4h, in correspondence to the brake operation. Thereby, the sub-piston 446 is pressed to press the control piston 445 and to unseat the ball valve 442, so that the high-pressure in the accumulator 431 is provided to the servo chamber 1A and the master pressure is increased with assistance of the driver's operation.

The static pressure mode is a mode that is to be executed when assistance is impossible, for example when the accumulator 431 fails. In the static pressure mode, the master pressure is increased simply by the driver's operation. It can be said that the pressurizing mode of the upstream side pressurizing mechanism BF1 is a linear mode during normal time and a failure mode combining the regulator mode and the static pressure mode. The pressurizing mode can be said as a mode that is mechanically (automatically) selected in correspondence to the state of the upstream side pressurizing mechanism BF1.

The plurality of pressurizing modes is set so that the pressurizing amount of the brake fluid with respect to an operation amount equivalent value corresponding to the operation amount on the brake pedal 10 is different from each other. The operation amount equivalent value is a stroke, stepping force or an instruction amount (command value) in the automatic driving, for example. In the first embodiment, the three pressurizing modes have different pressurizing amounts with respect to the stroke. In the meantime, the linear mode and the regulator mode can be switched by the first control unit 6 during the normal time.

In summary, the brake control device of the first embodiment is a device including the first control unit 6 configured to control the servo pressure generating device 4 capable of pressurizing the brake fluid with one pressurizing mode of the plurality of set pressurizing modes, the second control unit 8 configured to control the actuator 5 provided separate from the upstream side pressurizing mechanism BF1 and capable of pressurizing the brake fluid pressurized by the upstream side pressurizing mechanism BF1, and the communication line Z3 for transmitting the control information between the first control unit 6 and the second control unit 8, wherein the first control unit 6 and the second control unit 8 are configured to perform the cooperative control on the basis of the control information. Each of the first control unit 6 and the second control unit 8 can command the plurality of control modes including the pressurizing control of pressurizing the brake fluid, the holding control of holding the hydraulic pressure of the brake fluid, and the pressure reducing control of depressurizing the brake fluid, in at least a normal state in which there is no failure.

(Specific Control Upon Communication Interruption)

Herein, specific control, which is executed when transfer (communication) of the control information between the first control unit 6 and the second control unit 8 is interrupted, is described. Most communications including communication between both the control units 6 and 8 are configured by CAN. The communication interruption can be detected by a well-known method such as frame check. Here, the second control unit 8 includes a usual control unit 81, a mode estimation unit 82, and a specific control unit 83, as functions. The usual control unit 81 is configured to perform a usual control (the pressurizing control and the like) in a state in which communication is not interrupted, based on the target wheel pressure.

The mode estimation unit 82 estimates a current pressurizing mode (current situation) set in the upstream side pressurizing mechanism BF1 when the transfer of the control information between the first control unit 6 and the second control unit 8 is interrupted. Specifically, the mode estimation unit 82 is configured to acquire the stroke information and the master pressure information, and to estimate a current pressurizing mode, based on a value (pressurizing amount) of the master pressure with respect to a value (operation amount equivalent value) of the stroke.

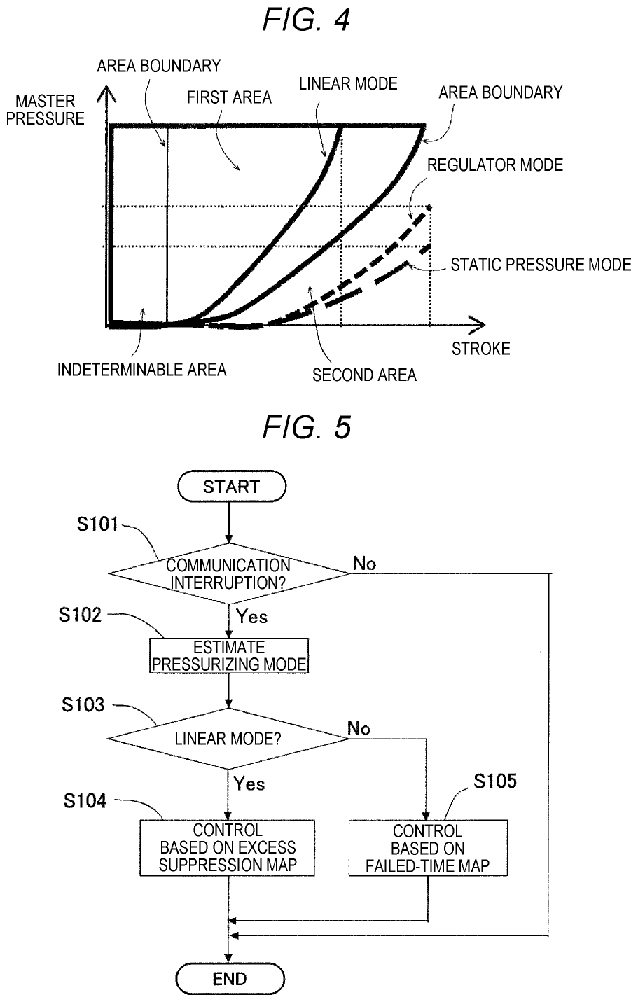

As shown in FIG. 4, the mode estimation unit 82 is configured to determine whether the value of the master pressure with respect to the value of the stroke is located in a first area, which includes a relation (function) between the stroke and the master pressure in the linear mode, in a map (determination map) of the relation between the stroke and the master pressure. Except the first area, a second area in which the relation (function) between the stroke and the master pressure in the failure mode (the regulator mode and the static pressure mode) is included, and an indeterminable area, which is a range in which the stroke is small and the master pressure cannot be detected even in assumption of the linear mode, are set (refer to an area boundary in FIG. 4).

If at least a current stroke and a current master pressure are known, a current area can be specified. The area determination (mode estimation) by the mode estimation unit 82 may be made by a predetermined determination time or may be periodically made by a predetermined number of times after the communication interruption (after interruption check). Also, in a case in which the value of the stroke is located in the indeterminable area, the mode estimation unit 82 stops the area determination, and may resume the area determination after the stroke becomes a value corresponding to the first area. In the indeterminable area in which the stroke is small, since high braking force is not required and the area is a play part, the control conforming to the pressurizing mode is not so required.

The specific control unit 83 is configured to control the actuator 5, in correspondence to the pressurizing mode estimated by the mode estimation unit 82, in a state in which the transfer of the control information is interrupted. In the specific control unit 83, a preset excess suppression map 83a (linear map) and a failed-time map 83b are stored. Each map indicates a relation between the stroke and the pressurizing amount (the target wheel pressure or the target deceleration). The excess suppression map 83a is set so that the pressurizing amount with respect to the stroke is smaller than the failed-time map 83b. The specific control unit 83 controls the actuator 5 on the basis of the excess suppression map 83a when the mode estimation unit 82 determines that the current pressurizing mode of the servo pressure generating device 4 is the linear mode, in the communication interruption state.

On the other hand, the specific control unit 83 controls the actuator 5 on the basis of the failed-time map 83b when the mode estimation unit 82 determines that the current pressurizing mode of the servo pressure generating device 4 is the failure mode (the regulator mode or the static pressure mode), in the communication interruption state. In the meantime, the excess suppression map 83a and the failed-time map 83b of the first embodiment are set to be different from a usual control to be performed in a communication state (normal state) on the basis of the target wheel pressure, which is calculated and transmitted to the second control unit by the first control unit 6.

Also, the second control unit 8 is configured so that, when the transfer of the control information is recovered while the specific control unit 83 controls the actuator 5 (i.e., during the specific control), the control (specific control) by the specific control unit 83 is to be kept until a braking state is released. In other words, while the specific control is executed, when the communication is recovered (returned) and the information transfer is thus resumed, the second control unit 8 continues the control (the control by the excess suppression map 83a or the failed-time map 83b) based on the pressurizing mode estimated by the mode estimation unit 82, irrespective of the pressurizing mode after the return, until the braking force becomes zero (until the brake operation is released).

The flow of the specific control of the first embodiment is described with reference to FIG. 5. First, the second control unit 8 determines whether the communication with the first control unit 6 is interrupted (S101). When it is determined that the communication interruption has occurred (S101: Yes), the mode estimation unit 82 estimates the current pressurizing mode of the upstream side pressurizing mechanism BF1, based on the acquired stroke information and master pressure information (S102). When the estimation result indicates the linear mode (S103: Yes), the specific control unit 83 selects the excess suppression map 83a, as the control map, and controls the actuator 5 on the basis of the excess suppression map 83a (S104). That is, the specific control unit 83 sets the relatively low target wheel pressure with respect to the stroke, based on the excess suppression map 83a. Thereby, the braking force is prevented from being excessive.

On the other hand, when the estimation result indicates the failure mode (S103: No), the specific control unit 83 selects the failed-time map 83b, as a control map, and controls the actuator 5 on the basis of the failed-time map 83b (S105). That is, the specific control unit 83 sets the relatively high target wheel pressure with respect to the stroke, based on the failed-time map 83b. Thereby, it is possible to make up for the loss of braking force due to the failure. In this way, the specific control unit 83 distinguishes the suppression of the excessive braking force and the security of the braking force, depending on the situations, and executes the specific control suitable for the pressurizing mode of the upstream side pressurizing mechanism BF1. In the meantime, during the normal communication state, the second control unit 8 is instructed by the first control unit 6 for the target wheel pressure (target deceleration).

According to the first embodiment, when the information transfer between both the control units 6 and 8 is interrupted, the mode estimation unit 82 estimates the current pressurizing mode of the upstream side pressurizing mechanism BF1, and the second control unit 8 controls the actuator 5, in correspondence to the estimated pressurizing mode. For this reason, it is possible to early execute the control suitable for the state of the upstream side pressurizing mechanism BF1, so that it is possible to prevent the braking force from being excessive with accuracy.

Also, since the mode estimation unit 82 estimates the pressurizing mode on the basis of the value of the master pressure with respect to the value of the stroke, i.e., the relativity between the stroke and the master pressure, it is possible to estimate the upstream state at a point in time at which the driver's brake operation is relatively small (i.e., the stroke is relatively small). Like this, according to the first embodiment, when the communication is interrupted, it is possible to early estimate the pressurizing mode (state) of the upstream side pressurizing mechanism BF1, and to accurately prevent the braking force from being excessive by switching the downstream side map (or a gain and the like) in correspondence to the pressurizing mode. That is, the brake feeling is improved.

Also, in the first embodiment, even when the communication is returned while the specific control unit 83 executes the specific control, the specific control is kept until the braking state is once over. Therefore, it is possible to prevent the driver from feeling uncomfortable due to the change of the map during the braking, for example. Then, when it becomes out of the braking, the control by the second control unit 8 returns to the similar control to the case in which the communication is possible.

### Second Embodiment

In a second embodiment, when the transfer of the control information between the first control unit 6 and the second control unit 8 is interrupted during the braking, the first control unit 6 sets the control mode to the holding control for a predetermined time period after the transfer of the control information between the first control unit 6 and the second control unit 8 is interrupted. In other words, the brake control device 100 includes a hydraulic pressure holding unit (6) that, when the transfer of the control information between the first control unit 6 and the second control unit 8 is interrupted during the braking, holds the hydraulic pressure (master pressure) of the brake fluid pressurized by the upstream side pressurizing mechanism BF1 for a predetermined time period after the transfer of the control information between the first control unit 6 and the second control unit 8 is interrupted.

For example, when the communication is interrupted while the pressurizing control is executed by the upstream side pressurizing mechanism BF1 and the actuator 5, the first control unit 6 changes a command to the upstream side pressurizing mechanism BF1 from the pressurizing control to the holding control for a predetermined time period. Thereby, even when the operation amount on the brake pedal 10 is reduced, the master pressure is temporarily held, so that it is possible to easily detect the master pressure (i.e., it is possible to easily perceive whether the pressurization is performed) and to easily estimate the pressurizing mode with accuracy. The other configurations are similar to the first embodiment.

### Third Embodiment

In a third embodiment, the mode estimation unit 82 is configured to, when the transfer of the control information between the first control unit 6 and the second control unit 8 is interrupted, estimate the current pressurizing mode set in the upstream side pressurizing mechanism BF1 on the basis of the pressurizing mode set in the upstream side pressurizing mechanism BF1 immediately before the interruption. That is, the mode estimation unit 82 is configured to store the information (for example, the current pressurizing mode) about the pressurizing mode of the upstream side pressurizing mechanism BF1 received from the first control unit 6, in a communicable state, and to estimate when the communication is interrupted, the pressurizing mode (the latest information before the interruption) stored immediately before the communication interruption, as the pressurizing mode after the communication interruption. According to this configuration, it is possible to quickly estimate the mode in a simple manner. However, in the third embodiment, since the state of the upstream side pressurizing mechanism BF1 after the communication interruption is not considered, when it is intended to estimate the mode corresponding to the actual current situation with higher accuracy, the first or second embodiment is preferably adopted.

(Others)

The present invention is not limited to the above embodiments. For example, the estimation time (determination time) of the mode estimation unit 82 may be set, in correspondence to a magnitude of the brake operation (stroke or stepping force). That is, the higher the brake operation is, the estimation time (determination time) can be further shortened, which can contribute to the early estimation. Also, during the automatic driving, when the communication is interrupted, the mode estimation unit 82 may estimate the pressurizing mode on the basis of a pressurization instruction amount common to the first control unit 6, which is transmitted from the automatic driving ECU and the like to the second control unit 8, and the master pressure detected by the pressure sensor Y. That is, even in the case in which the communication is interrupted during the automatic driving, it is possible to estimate the state of the upstream side pressurizing mechanism BF1, based on the common pressurization instruction amount and the master pressure (upstream pressurizing amount) to be generated by the upstream side pressurizing mechanism BF1.

Also, a rule, which indicates that, when the communication is interrupted, the master pressure is increased in a pulse manner by the upstream side pressurizing mechanism BF1, irrespective of the brake operation, may be set in the first control unit 6, and the second control unit 8 may estimate the pressurizing mode by checking an output aspect of the master pressure. In the case of the linear mode, the master pressure is varied by the pulsating pressurization, i.e., the pulsating opening and closing of the booster valve 42. On the other hand, in the case of the failure mode, the master pressure is not varied by an electric failure of the booster valve 42 and/or a failure of the accumulator 431. The mode estimation unit 82 may be configured to estimate the current pressurizing mode, based on the variation in master pressure with respect to a predetermined pressurization command (here, the pulsating pressurization) to be automatically applied to the upstream side pressurizing mechanism BF1, irrespective of the brake operation, upon the communication interruption. The predetermined pressurization command may be issued by a device other than the first control unit 6 or the first control unit 6. That is, the brake control device 100 may include a pressurization command unit configured to issue a predetermined pressurization command to the upstream side pressurizing mechanism BF1 upon the communication interruption.

Also, the brake control device may be applied to a hybrid vehicle. In the hybrid vehicle, since a regenerative cooperative control is executed by the two pressurizing mechanisms BF1 and 5, the cooperative control by the first control unit 6 and the second control unit 8 is necessarily required and the applying of the present invention is effective. Also, even in a vehicle other than the hybrid vehicle, the adjustment of the braking force is performed in the actuator 5 (downstream side pressurizing mechanism) capable of finely adjusting the wheel pressure relatively easily, so that it is possible to generate a favorable brake feeling corresponding to the situation. In this way, the present invention is effectively applied even to the configuration in which the downstream side pressurizing mechanism is used so as to make the brake feeling.

Also, in a case in which the first control unit 6 can switch the linear mode and the regulator mode, the first control unit may be set to select the linear mode as much as possible during the normal time, even when the communication is interrupted. For example, when a value received by the first control unit 6 and a value received by the second control unit 8 are different with respect to the detection value of the stroke sensor 71, the first control unit 6 and the second control unit 8 cannot determine which of the values is trustable, and the first control unit 6 can intentionally switch the pressurizing mode of the upstream side pressurizing mechanism BF1 from the linear mode to the regulator mode. In this configuration, when it is checked that the communication is interrupted, the first control unit 6 may prohibit the change of the pressurizing mode until the braking state is released. Thereby, it is possible to prevent an erroneous determination due to the change of the pressurizing mode.

Also, the control (specific control) corresponding to the estimated pressurizing mode is not limited to the change of the map or gain, and the control suitable for the upstream side state may be performed. For example, when the upstream side is the linear mode (normal), the pressurizing amount (the target wheel pressure) with respect to the operation amount equivalent value (stroke, stepping force or the like) may be set smaller, as compared to the case in which the upstream side is the failure mode. The map set by the second control unit 8 can be said as a downstream deceleration request map. Also, the regulator 44 maybe a spool valve type, other than the ball valve type. Also, the upstream side pressurizing mechanism is not limited to the configuration in which the high pressure source and the electromagnetic valve are used, and may have a configuration in which an electric booster (for example, a system configured to actuate a regulator with a motor) is used. Also, the hydraulic braking force generating device BF may include a stepping force sensor configured to transmit a detection result to the first control unit 6 and the second control unit 8. Also, the pipe configuration may be an X-pipe. Also, the mode estimation unit 82 may be set to further determine the regulator mode and the static pressure mode. Thereby, it is possible to perform the finer specific control (for example, by three maps).

1. A brake control device comprising:
a first control unit configured to control a first pressurizing mechanism capable of pressurizing a brake fluid with one pressurizing mode of a plurality of set pressurizing modes;
a second control unit configured to control a second pressurizing mechanism provided separate from the first pressurizing mechanism and capable of pressurizing the brake fluid pressurized by the first pressurizing mechanism, and
a communication line configured to transfer control information between the first control unit and the second control unit,
wherein the first control unit and the second control unit are configured to perform a cooperative control on the basis of the control information,
wherein the brake control device is provided with a mode estimation unit for estimating a current pressurizing mode set in the first pressurizing mechanism when the transfer of the control information between the first control unit and the second control unit is interrupted, and
wherein the second control unit is provided with a specific control unit configured to control the second pressurizing mechanism according to the pressurizing mode estimated by the mode estimation unit in a state in which the transfer of the control information is interrupted.

2. The brake control device according to claim 1, wherein the plurality of pressurizing modes is set so that a pressurizing amount of the brake fluid with respect to an operation amount equivalent value, which corresponds to an operation amount on a brake operating member, is different from each other, and
wherein the mode estimation unit is configured to estimate the current pressurizing mode set in the first pressurizing mechanism, based on the pressurizing amount with respect to the operation amount equivalent value.

3. The brake control device according to claim 2, further comprising a hydraulic pressure holding unit that, when the transfer of the control information between the first control unit and the second control unit is interrupted during braking, holds a hydraulic pressure of the brake fluid pressurized by the first pressurizing mechanism for a predetermined time period after the transfer of the control information between the first control unit and the second control unit is interrupted.

4. The brake control device according to claim 1, wherein when the transfer of the control information between the first control unit and the second control unit is interrupted, the mode estimation unit estimates the current pressurizing mode set in the first pressurizing mechanism, based on the pressurizing mode set in the first pressurizing mechanism immediately before the interruption.

5. The brake control device according to claim 1, wherein when the transfer of the control information is recovered while the specific control unit controls the second pressurizing mechanism, the second control unit keeps the control by the specific control unit until a braking state is released.

6. The brake control device according to claim 2, wherein when the transfer of the control information is recovered while the specific control unit controls the second pressurizing mechanism, the second control unit keeps the control by the specific control unit until a braking state is released.

7. The brake control device according to claim 3, wherein when the transfer of the control information is recovered while the specific control unit controls the second pressurizing mechanism, the second control unit keeps the control by the specific control unit until a braking state is released.

8. The brake control device according to claim 4, wherein when the transfer of the control information is recovered while the specific control unit controls the second pressurizing mechanism, the second control unit keeps the control by the specific control unit until a braking state is released.
